(19) United States
(12) Patent Application Publication
(10) Pub. No.: US 2023/0386720 A1
(43) Pub. Date: Nov. 30, 2023

(54) INDUCTOR

(71) Applicant: TDK CORPORATION, Tokyo (JP)

(72) Inventors: Hajime AMANO, Tokyo (JP); Kensuke ARA, Tokyo (JP); Kazuhiro YOSHIDOME, Tokyo (JP); Akito HASEGAWA, Tokyo (JP)

(73) Assignee: TDK CORPORATION, Tokyo (JP)

(21) Appl. No.: 18/324,609

(22) Filed: May 26, 2023

(30) Foreign Application Priority Data
May 30, 2022 (JP) 2022-087863
May 23, 2023 (JP) 2023-084722

(51) Int. Cl. H01F 10/00; H01F 10/13

(52) U.S. Cl. CPC H01F 10/007; H01F 10/131; H01F 10/132

(57) ABSTRACT

An inductor includes a magnetic core portion and a coil portion. The magnetic core portion is a multilayer film in which a nanogranular magnetic film and a soft magnetic alloy film are alternately stacked. The nanogranular magnetic film has a structure in which nano-domains of a first phase are dispersed in a second phase. The first phase contains one or more selected from Fe and Co, and the second phase contains one or more selected from O, N, and F. The volume ratio of the first phase to the total volume of the first phase and the second phase is 60% or less. The soft magnetic alloy film contains one or more selected from Fe and Co. The total amount of Fe, Co, and Ni in the soft magnetic alloy film is 70 at % or more.

### BACKGROUND

The present invention relates to an inductor.

In recent years, mobile devices such as smartphones and smart watches are required to have a larger display screen, an increased battery capacity, a smaller size, and a lighter weight at the same time. The demands for a larger display screen and an increased battery capacity are demands that conflict with the demands for a smaller size and a lighter weight. In order to meet these conflicting demands, miniaturization of circuit boards is required. Then, miniaturization of a power supply circuit, which occupies a particularly large area of the circuit board, is required. However, it is difficult to miniaturize the power supply circuit. This is because it is difficult to miniaturize an inductor required for the power supply circuit.

As a method for miniaturizing the inductor, there is a method of increasing the driving frequency of the power supply circuit. However, when a conventional switching element using silicon as a semiconductor is used in the power supply circuit, it is difficult to increase the driving frequency of the power supply circuit. Therefore, it is difficult to drive the power supply circuit at high frequencies.

In recent years, GaN, SiC, and the like have been put to practical use as semiconductors used for switching elements. In particular, switching elements using GaN are easy to drive at high frequencies. As a result, it has become easier to increase the driving frequency of the power supply circuit by using switching elements using semiconductors such as GaN.

An example of a switching element is a transistor. A transistor using a semiconductor, such as GaN, is currently expensive. However, in the future, it is expected that switching elements using semiconductors, such as GaN, will be increasingly applied to power supply circuits that are required to be miniaturized, for example, power supply circuits used inside smartphones or smartwatches.

As switching elements can be adapted to high-frequency driving, there is an increasing demand for small inductors that can be adapted to high-frequency driving.

In order to reduce the size of an inductor, it is effective to manufacture a thin film inductor. Specifically, a thin film inductor can be manufactured by stacking a coil and a magnetic core on a substrate using a semiconductor process. In this case, a magnetic film forms the magnetic core of the thin film inductor. In order for the thin film inductor to have the required characteristics, the magnetic film should have the required characteristics. A large current flows through an inductor for a power supply. For this reason, the inductor for a power supply is required to have a DC superimposition characteristic. Therefore, the material of the magnetic core included in the inductor for a power supply, that is, the magnetic film included in the inductor for a power supply is required to have a high saturation magnetic flux density Bs. Furthermore, in order to be adapted to high-frequency driving, the magnetic film is required to have a high specific resistance. This is because when the specific resistance is low, a magnetic loss tan δ during high-frequency driving increases.

Patent Document 1 describes an amorphous alloy having a structure in which fine particles containing a metal element are dispersed in an amorphous film formed of a nitrogen compound. Currently, such a structure is sometimes called a nanogranular structure.

Patent Document 2 describes that a soft magnetic multilayer film having a structure in which a soft magnetic film and an altered layer, which is formed by oxidizing or nitriding the surface of the soft magnetic film, are alternately stacked is used as a magnetic core of an inductor.

A nanogranular film having a nanogranular structure has a high specific resistance and a small magnetic loss tan δ during high-frequency driving. Therefore, the use of a nanogranular film as a magnetic film included in the inductor for power supplies driven at high frequencies has been studied. However, a nanogranular film with a high specific resistance tends to have a low saturation magnetic flux density Bs. For this reason, it becomes necessary to increase the thickness of the nanogranular film itself, which increases the process load.
Patent Document 1: JP S60-152651 A
Patent Document 2: JP 2000-054083 A

### SUMMARY

It is an object of the present invention to provide an inductor using a magnetic core having a relatively satisfactory saturation magnetic flux density Bs and a small magnetic loss tan δ.

In order to achieve the aforementioned object, an inductor according to the present invention including:
a magnetic core portion; and
a coil portion,
wherein the magnetic core portion is a multilayer film in which a nanogranular magnetic film and a soft magnetic alloy film are alternately stacked,
the nanogranular magnetic film has a structure in which nano-domains of a first phase are dispersed in a second phase,
the first phase contains one or more selected from Fe and Co, and the second phase contains one or more selected from O, N, and F,
a volume ratio of the first phase to a total volume of the first phase and the second phase is 65% or less,
the soft magnetic alloy film contains one or more selected from Fe and Co, and
a total amount of Fe, Co, and Ni in the soft magnetic alloy film is 70 at % or more nano-domain.

A film thickness of the soft magnetic alloy film may be equal to or less than a film thickness of each nanogranular magnetic film, and the film thickness of the soft magnetic alloy film may be 100 nm or more and 500 nm or less.

The first phase may have a crystal structure, and an average crystal grain size of crystals contained in the crystal structure may be 20 nm or less.

The soft magnetic alloy film may contain an Fe-based amorphous alloy or a Co-based amorphous alloy.

The coil portion may include a solenoid type coil.

### BRIEF DESCRIPTION OF THE DRAWINGS

FIG. 1 is a plan view of an inductor according to an embodiment of the present invention;

FIG. 2 is a cross-sectional view of a main part taken along the line IA-IA in FIG. 1;

FIG. 3 is a schematic cross-sectional view of a nanogranular magnetic film;

FIG. 4 is a schematic diagram for explaining a method for measuring a specific resistance ρ in a direction perpendicular to the plane; and

FIG. 5 is a cross-sectional view of a main part taken along the line IB-IB in FIG. 4.

### DETAILED DESCRIPTION

Hereinafter, the present invention will be described based on embodiments shown in the drawings.

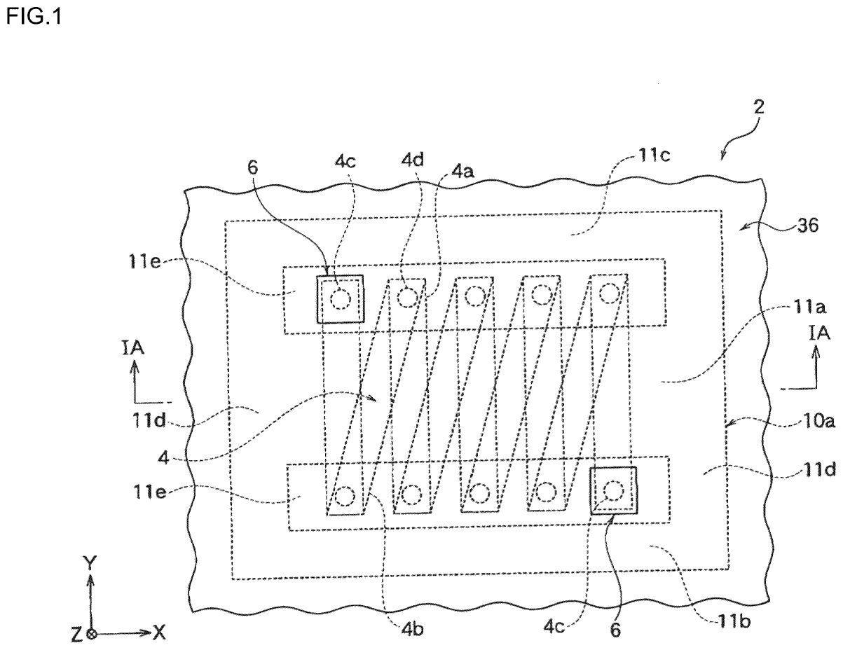

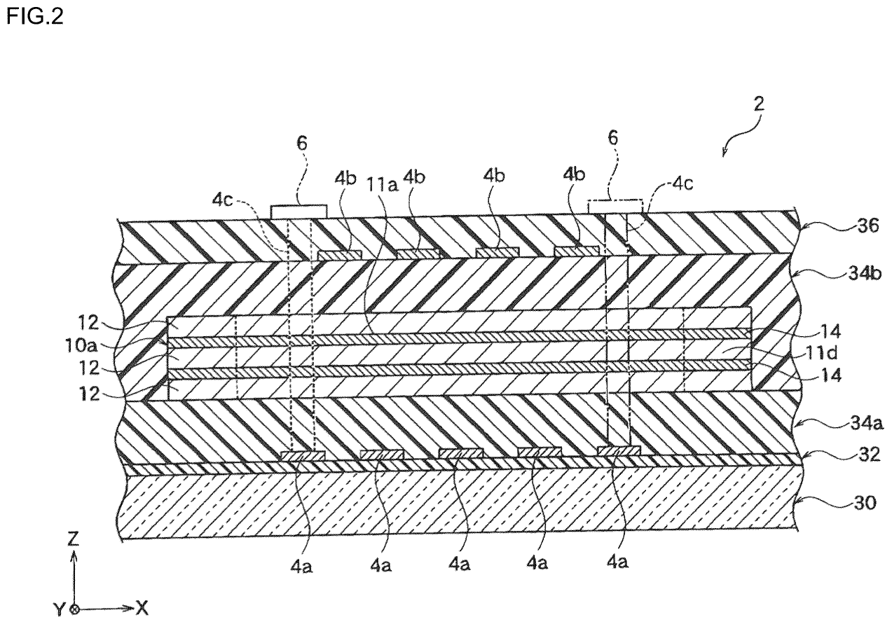

As an embodiment of an inductor, an inductor 2 shown in FIGS. 1 and 2 will be described.

(Overall Structure)

As shown in FIGS. 1 and 2, the inductor 2 has a coil portion 4 and a magnetic core portion 10a. The coil portion 4 and the magnetic core portion 10a are stacked in a Z-axis direction on the surface of a support substrate 30 with insulating layers 32 to 36 interposed therebetween, and the stacking plane is substantially parallel to the surface of the support substrate 30.

By adopting such a stacking structure, the coil portion 4 and the magnetic core portion 10a are stacked on the support substrate 30 so as to be electrically separated from each other. In addition, in the diagrams, the Z axis matches the stacking direction of the inductor 2, and X, Y, and Z axes are approximately perpendicular to each other. Then, the coil portion 4 of the inductor 2 includes a solenoid type coil. That is, the coil portion 4 has a shape that three-dimensionally surrounds the magnetic core portion 10a that is formed in parallel to the plane (XY plane in FIGS. 1 and 2).

(Magnetic Core Portion)

As shown in FIGS. 1 and 2, the magnetic core portion 10a has a planar shape similar to a gap-filled EE core. That is, slit portions 11e are formed on both sides in the Y-axis direction of a magnetic core center portion 11a around which the coil portion 4 is wound, and magnetic core side portions 11b and 11c are formed on the outer sides of the slit portions 11e. In addition, two magnetic core connecting portions 11d are formed in parallel with the Y-axis direction so as to connect the magnetic core center portion 11a, the magnetic core side portion 11b, and the magnetic core side portion 11c to each other.

As shown in FIG. 2, the magnetic core portion 10a includes a multilayer film in which a plurality of nanogranular magnetic films 12 and soft magnetic alloy films 14 are alternately stacked.

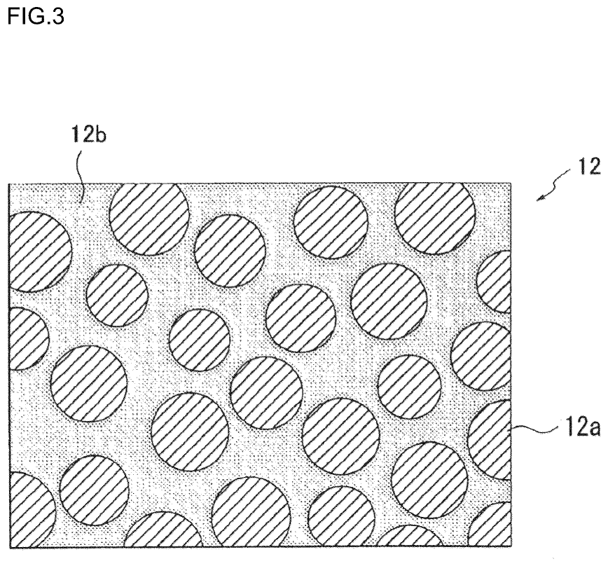

As shown in FIG. 3, the nanogranular magnetic film 12 has a structure in which nano-domains of a first phase 12a are dispersed in a second phase 12b.

Since the magnetic core portion 10a includes the above-described multilayer film, the magnetic core portion 10a having a high saturation magnetic flux density B s and a high specific resistance ρ in a direction perpendicular to the plane (Z-axis direction in FIGS. 1 and 2) can be obtained.

The number of stacked layers in the multilayer film may be two or more. That is, it is preferable that at least two nanogranular magnetic films 12 and at least two soft magnetic alloy films 14 are provided. There is no particular upper limit to the number of stacked layers in the multilayer film. For example, the upper limit of the number of stacked layers in the multilayer film may be 100 or less. The total film thickness of the multilayer film is not particularly limited. For example, the total film thickness of the multilayer film may be 1000 nm or more and 60000 nm or less.

There is no particular limitation on the stacking order of the nanogranular magnetic film 12 and the soft magnetic alloy film 14. As shown in FIG. 2, the two films including the surface perpendicular to the Z-axis direction of the multilayer film may both be the nanogranular magnetic film 12. However, one of the films including the surface perpendicular to the Z-axis direction of the multilayer film may be the soft magnetic alloy film 14. The two films including the surface perpendicular to the Z-axis direction of the multilayer film may both be the soft magnetic alloy film 14.

There is no particular limitation on the film thickness of one layer of the soft magnetic alloy film 14. The film thickness of one layer of the soft magnetic alloy film 14 may be equal to or less than the film thickness of one layer of the nanogranular magnetic film 12. In addition, a value obtained by dividing the film thickness of one layer of the soft magnetic alloy film 14 by the film thickness of one layer of the nanogranular magnetic film 12 may be 0.20 or more and 1.00 or less. As the film thickness of the soft magnetic alloy film 14 is relatively smaller, it becomes difficult to improve the saturation magnetic flux density Bs. As the film thickness of the soft magnetic alloy film 14 is relatively larger, the specific resistance ρ of the multilayer film tends to decrease.

The film thickness of one layer of the soft magnetic alloy film 14 may be 100 nm or more and 500 nm or less. The film thickness of one layer of the nanogranular magnetic film 12 may be 400 nm or more and 2000 nm or less.

When the magnetic core portion 10a has a single-layer structure including only the nanogranular magnetic film 12, it is difficult to achieve both the saturation magnetic flux density Bs and the specific resistance ρ that are satisfactory. This is because the nanogranular magnetic film 12 tends to have an improved saturation magnetic flux density Bs but a reduced specific resistance ρ as the volume ratio of the first phase 12a increases. Particularly in the high frequency range, as the specific resistance ρ decreases, the eddy current increases, and accordingly, the magnetic loss tan δ increases.

When the magnetic core portion 10a has a single-layer structure including only the soft magnetic alloy film 14, the saturation magnetic flux density Bs is improved, but the specific resistance ρ is too low. A soft magnetic amorphous alloy film is known as the soft magnetic alloy film 14 having a relatively high specific resistance p. However, the specific resistance ρ is still too low. As a result, particularly in the high frequency range, the magnetic loss tan δ increases.

In addition, when the magnetic core portion 10a has a single-layer structure including only the soft magnetic alloy film 14, there is also a problem that it is difficult to increase the film thickness of the soft magnetic alloy film 14. Specifically, it is difficult to make the film thickness of the soft magnetic alloy film 14 larger than 500 nm. This is because the magnetic loss tan δ greatly increases if the film thickness of the soft magnetic alloy film 14 is larger than 500 nm.

In addition, when a SiO₂ film formed of silicon oxide is used instead of a nanogranular magnetic film, the process load during film deposition increases. Furthermore, the saturation magnetic flux density Bs is reduced.

As shown in FIGS. 1 and 2, when the coil portion 4 includes a solenoid type coil, theoretically, the magnetic field flows only in the XY plane direction (in-plane direction of the multilayer film) in FIGS. 1 and 2, and the current flows only in the Z-axis direction (direction perpendicular to the plane of the multilayer film) in FIGS. 1 and 2. That is, the magnetic field passing through the inside of the magnetic core portion 10a flows only in the in-plane direction of the multilayer film.

Therefore, as shown in FIGS. 1 and 2, when the coil portion 4 includes a solenoid type coil, even if the specific resistance ρ in the XY plane direction (in-plane direction of the multilayer film) is low, the eddy current is less likely to increase and the magnetic loss tan δ is less likely to increase. That is, when the coil portion 4 includes a solenoid type coil, it is preferable that the magnetic core portion 10a has a high saturation magnetic flux density Bs and a high specific resistance ρ in the Z-axis direction (direction perpendicular to the plane of the multilayer film). Then, an inductor having such a magnetic core portion 10a has excellent characteristics.

When the magnetic core portion 10a is the multilayer film described above, it becomes easier to improve the saturation magnetic flux density Bs while appropriately maintaining the specific resistance ρ in the direction perpendicular to the plane as compared with a case where the magnetic core portion 10a is formed only by a nanogranular magnetic film.

When the magnetic core portion 10a is the multilayer film described above, the specific resistance ρ in the direction perpendicular to the plane can be made sufficiently high and the magnetic loss tan δ can be made sufficiently small, as compared with a case where the magnetic core portion 10a is formed only by a soft magnetic alloy film. Furthermore, since a large number of soft magnetic alloy films having a small film thickness can be stacked, the total thickness of the soft magnetic alloy films can be increased while suppressing an increase in the magnetic loss tan δ.

(Nanogranular Magnetic Film)

As shown in FIG. 3, the nanogranular magnetic film 12 has a structure in which nano-domains of the first phase 12a are dispersed in the second phase 12b, that is, a nanogranular structure.

The average size of the nano-domains of the first phase 12a is a nanometer size, that is, 50 nm or less. The average size of the nano-domains of the first phase 12a may be 30 nm or less. There is no particular limitation on the method for measuring the size of the nano-domain of the first phase 12a. For example, the circle equivalent diameter of the nano-domain of the first phase 12a in the cross section of the nanogranular magnetic film 12 may be the size of the nano-domain of the first phase 12a.

In addition, the circle equivalent diameter of the nano-domain of the first phase 12a in the cross section of the nanogranular magnetic film 12 is the diameter of a circle having an area equal to the area of the nano-domain of the first phase 12a in the cross section of the nanogranular magnetic film 12.

The first phase 12a is a phase containing a metal element. Specifically, the first phase 12a contains one or more selected from Fe and Co. The first phase 12a may further contain Ni. There is no particular limitation on how one or more elements selected from Fe and Co are contained in the first phase 12a. For example, one or more elements selected from Fe and Co may be contained in the first phase 12a as a simple substance, or may be contained in the first phase 12a as an alloy with other metal elements, or may be contained in the first phase 12a as a compound with other elements. The compound contained in the first phase 12a may be an oxide magnetic material. For example, the compound contained in the first phase 12a may be ferrite.

There is no particular limitation on the total amount of Fe, Co, and/or Ni in the first phase 12a. The ratio of the total amount of Fe, Co, and Ni to the total amount of Fe, Co, Ni, X1, and X2 in the first phase 12a may be 70 at % or more, or may be 75 at % or more, or may be 80 at % or more.

There is no particular limitation on the total amount of Fe and Co in the first phase 12a. The ratio of the total amount of Fe and Co to the total amount of Fe, Co, and Ni in the first phase 12a may be 70 at % or more.

X1 is a metalloid element. For example, X1 may be one or more metalloid elements selected from B, Si, P, C, and Ge, or may be one or more metalloid elements selected from B, P, and C.

X2 is a metal element other than Fe, Co, and Ni. For example, X2 may be one or more metal elements selected from Cr, Ti, Zr, Hf, V, Nb, Ta, Mo, W, Mn, Cu, Ag, Pt, Zn, Al, Sn, Bi, Y, La, and Mg, or may be one or more metal elements selected from Cr and

Pt.

The first phase 12a may contain elements other than Fe, Co, Ni, X1, and X2. The ratio of the total amount of elements other than Fe, Co, Ni, X1, and X2 to the total amount of Fe, Co, Ni, X1, and X2 may be 5 at % or less.

The second phase 12b is a phase containing a non-metal element. Specifically, the second phase 12b may contain one or more selected from O, N, and F. There is no particular limitation on how one or more elements selected from O, N, and F are contained in the second phase 12b. For example, one or more elements selected from O, N, and F may be contained in the second phase 12b as compounds with other elements.

There is no particular limitation on the types of compounds contained in the second phase 12b. Examples of the compounds include SiO₂, Al₂O₃, AlN, ZnO, MgF₂, SiON, BeF₂, SnO₂, BN, GaO₂, GeO₂, and Si₃N₄·Al₂O₃. Compounds may be one or more selected from SiO₂, Al₂O₃, AlN, ZnO, MgF₂, GaO₂, and Si₃N₄·Al₂O₃, or may be SiO₂.

The volume ratio of the first phase 12a to the total volume of the first phase 12a and the second phase 12b is 65% or less. That is, assuming that the volume of the first phase 12a is V₁ and the volume of the second phase 12b is V₂, V₁/(V₁+V₂) is 0.65 or less. The volume ratio of the first phase 12a to the total volume of the first phase 12a and the second phase 12b may be 60% or less. That is, V₁/(V₁+V₂) may be 0.60 or less. When the volume ratio of the first phase 12a to the total volume of the first phase 12a and the second phase 12b is too large, it is difficult to sufficiently improve the saturation magnetic flux density Bs of the multilayer film. Furthermore, since the specific resistance ρ of the multilayer film is too low, the magnetic loss tan δ tends to be too high.

Although there is no lower limit to the volume ratio of the first phase 12a to the total volume of the first phase 12a and the second phase 12b, the volume ratio of the first phase 12a to the total volume of the first phase 12a and the second phase 12b may be 30% or more or may be 40% or more. That is, V₁/(V₁+V₂) may be 0.30 or more, or may be 0.40 or more. As the volume ratio of the first phase 12a to the total volume of the first phase 12a and the second phase 12b decreases, the specific resistance ρ increases, but the saturation magnetic flux density Bs decreases.

There is no particular limitation on the method for measuring the volume ratio of the first phase 12a to the total volume of the first phase 12a and the second phase 12b. For example, the volume ratio of the first phase 12a to the total volume of the first phase 12a and the second phase 12b can be calculated from the XRF measurement results for the nanogranular magnetic film 12. In addition, the volume ratio of the first phase 12a to the total volume of the first phase 12a and the second phase 12b may be calculated from the area ratio of the first phase 12a to the total area of the first phase 12a and the second phase 12b by observing the cross section of the nanogranular magnetic film 12 with a TEM. In this case, the area ratio is converted into the volume ratio.

The nanogranular magnetic film 12 may contain only the first phase 12a and the second phase 12b, but may further contain different phases other than the first phase 12a and the second phase 12b. Although there is no particular limitation on the ratio between different phases, the area ratio between different phases may be 10% or less when the cross section of the nanogranular magnetic film 12 is observed with a TEM. In addition, parts or all of different phases may be voids.

In FIG. 3, all the first phases 12a are separated from each other, but some of the first phases 12a may be in contact with each other.

All the nanogranular magnetic films 12 included in the multilayer film do not have to be of the same type, and different types of nanogranular magnetic films 12 may be included in the multilayer film.

(Soft Magnetic Alloy Film)

The soft magnetic alloy film 14 contains one or more selected from Fe and Co. Then, the total amount of Fe, Co, and Ni in the soft magnetic alloy film 14 is 70 at % or more. The total amount of Fe, Co, and Ni in the soft magnetic alloy film 14 may be 74 at % or more. When the composition of the soft magnetic alloy film 14 is within the above range, the saturation magnetic flux density Bs of the soft magnetic alloy film 14 is sufficiently high. Therefore, the saturation magnetic flux density Bs of the multilayer film is sufficiently high.

There is no particular limitation on the total amount of Fe and Co in the soft magnetic alloy film 14. The ratio of the total amount of Fe and Co to the total amount of Fe, Co, and Ni in the soft magnetic alloy film 14 may be 70 at % or more.

Although there is no particular limitation on the saturation magnetic flux density B s of the soft magnetic alloy film 14, the saturation magnetic flux density Bs of the soft magnetic alloy film 14 may exceed 1.00 T or may be 2.00 T or less.

All the soft magnetic alloy films 14 included in the multilayer film do not have to be of the same type, and different types of soft magnetic alloy films 14 may be included in the multilayer film. In this case, the average composition of all the soft magnetic alloy films 14 included in the multilayer film may be within the above range. In addition, the average saturation magnetic flux density of all the soft magnetic alloy films 14 included in the multilayer film may be within the above range.

The soft magnetic alloy film 14 may contain an Fe-based amorphous alloy or Co-based amorphous alloy. A soft magnetic alloy film containing these alloys can have a high saturation magnetic flux density even when no heat treatment is performed or heat treatment is performed only at a low temperature of 300° C. or less.

The Fe-based amorphous alloy is an amorphous alloy with an Fe content of 70 at % or more. In addition, the half or less of Fe in terms of the atomic number ratio may be substituted with Co. The Co-based amorphous alloy is an amorphous alloy with a Co content of 70 at % or more. In addition, the half or less of Co in terms of the atomic number ratio may be substituted with Fe.

There is no particular limitation on the method for checking whether or not the soft magnetic alloy film 14 is an amorphous alloy. For example, whether or not the soft magnetic alloy film 14 is an amorphous alloy may be checked using XRD.

(Coil Portion)

As shown in FIGS. 1 and 2, the coil included in the coil portion 4 includes a bottom surface side conductor layer 4a, a top surface side conductor layer 4b, a via hole electrode for extraction 4c, a via hole electrode for connection 4d, and an extraction electrode 6. The bottom surface side conductor layer 4a has a plurality of electrode patterns separated from each other. The number of turns of the coil included in the coil portion 4 is determined by the number of patterns in the bottom surface side conductor layer 4a. There is no particular limitation on the number of turns of the coil included in the coil portion 4.

Each of the plurality of electrode patterns in the bottom surface side conductor layer 4a is an approximately rectangular thin film. Then, the plurality of electrode patterns in the bottom surface side conductor layer 4a are arranged side by side in the X-axis direction at predetermined distances therebetween. In addition, the plurality of electrode patterns is formed such that their long sides are approximately parallel to the Y-axis direction.

The top surface side conductor layer 4b is formed so as to face the bottom surface side conductor layer 4a. Then, the top surface side conductor layer 4b has a plurality of electrode patterns separated from each other.

Each of the plurality of electrode patterns in the top surface side conductor layer 4b is an approximately oblique thin film. Then, the plurality of electrode patterns in the top surface side conductor layer 4b are arranged side by side in the X-axis direction at predetermined distances therebetween. The direction of each of the long sides of the plurality of electrode patterns in the top surface side conductor layer 4b is not parallel to the Y-axis direction. As shown in FIG. 1, the direction of each of the long sides of the plurality of electrode patterns in the top surface side conductor layer 4b is oblique.

The stacking area and the layer thickness of the bottom surface side conductor layer 4a are not particularly limited. The stacking area and the layer thickness of the top surface side conductor layer 4b are not particularly limited. The pitch interval between the electrode patterns of the bottom surface side conductor layer 4a and the pitch interval between the electrode patterns of the top surface side conductor layer 4b are not also particularly limited.

The magnetic core portion 10a and intermediate insulating layers 34a and 34b are stacked between the bottom surface side conductor layer 4a and the top surface side conductor layer 4b. The bottom surface side conductor layer 4a and the top surface side conductor layer 4b are electrically connected in series to each other by a plurality of via hole electrodes for connection 4d formed so as to penetrate the intermediate insulating layers 34a and 34b. In addition, at the end of the bottom surface side conductor layer 4a to which the via hole electrode for connection 4d is not connected, the via hole electrode for extraction 4c is formed so as to penetrate the intermediate insulating layers 34a and 34b and a top surface side insulating layer 36.

The via hole electrode for extraction 4c is formed at two diagonal positions of the coil portion 4, and is connected to the extraction electrode 6 at the upper end along the Z axis. As shown in FIG. 1, the extraction electrode 6 is exposed on the surface of the top surface side insulating layer 36. A current is supplied to the coil included in the coil portion 4 through the extraction electrode 6.

The material of the coil included in the coil portion 4 is not particularly limited as long as the material is a conductive material. Examples of the material of the coil included in the coil portion 4 include Cu, Ni, Al, Cr, Au, Ag, and alloys thereof (Cu—Ni alloy and the like). In addition, the coil included in the coil portion 4 may have a stacked structure in which two or more types of conductive materials are stacked. The materials of the bottom surface side conductor layer 4a, the top surface side conductor layer 4b, the via hole electrode for extraction 4c, the via hole electrode for connection 4d, and the extraction electrode 6 do not need to be the same, and may be selected as appropriate. For example, since the extraction electrode 6 is connected to an external terminal through solder or conductive adhesive, the material of the extraction electrode 6 is preferably Cu, Ni, Au, or a Cu—Ni alloy, and Cu or Au is particularly preferable.

(Support Substrate)

There is no particular limitation on the material of the support substrate 30. Examples of the support substrate 30 include a silicon substrate, an aluminum oxide substrate, Ni foil, a glass substrate, and a resin substrate (glass epoxy substrate and the like).

There is no particular limitation on the thickness of the support substrate 30. The support substrate 30 may be made thin by polishing as appropriate. In addition, the support substrate 30 may be removed as appropriate.

(Insulating Layer)

A bottom surface side insulating layer 32, the intermediate insulating layers 34a and 34b, and the top surface side insulating layer 36 electrically insulate the constituents of the inductor 2 from each other. There is no particular limitation on the material of each insulating layer. Examples of the material of each insulating layer include oxides (silicon oxide, alumina, and the like), nitrides (AlN and the like), resins (polyimide and the like), and hardened photoresists. In addition, when the support substrate 30 is an insulator, the support substrate 30 may also serve as the bottom surface side insulating layer 32. When the top surface side conductor layer 4b may be exposed, the top surface side insulating layer 36 may be omitted.

The shape and size of the inductor 2 may be appropriately determined according to the purpose or application.

(Method of Manufacturing an Inductor)

Next, a method of manufacturing the inductor 2 shown in FIG. 1 will be specifically described.

First, the bottom surface side insulating layer 32 is formed on the entire surface of the support substrate 30. There is no particular limitation on the method of forming the bottom surface side insulating layer 32. For example, there is a method of forming the bottom surface side insulating layer 32 by chemical vapor deposition (CVD). For example, when the bottom surface side insulating layer 32 is formed of silicon oxide, the bottom surface side insulating layer 32 can be formed by CVD using tetraethoxysilane (TEOS) as a raw material. In addition, when the support substrate 30 is an insulator, the bottom surface side insulating layer 32 may not be formed.

Then, the bottom surface side conductor layer 4a is formed. First, an electrode film is formed on the entire surface of the bottom surface side insulating layer 32 (support substrate 30 when the support substrate 30 also serves as the bottom surface side insulating layer 32). There is no particular limitation on the method of forming the electrode film. For example, a sputtering method can be used.

Then, a dry film resist is laminated on the surface of the electrode film. Then, the dry film resist is exposed and developed so as to form an opening where the bottom surface side conductor layer 4a is to be formed.

By plating, a plated film that becomes the bottom surface side conductor layer 4a is selectively deposited in the opening where the bottom surface side conductor layer 4a is to be formed. Thereafter, the dry film resist is removed by resist peeling. Furthermore, the electrode film in portions other than the bottom surface side conductor layer 4a is removed. There is no particular limitation on the method of removing the electrode film. For example, ion milling or dry etching can be used. By the processes described above, the patterned bottom surface side conductor layer 4a is formed.

Then, the intermediate insulating layer 34a is formed on the surface of the bottom surface side conductor layer 4a (the surface of the bottom surface side insulating layer 32 in a portion where the bottom surface side conductor layer 4a is not formed). For example, a photoresist that becomes the intermediate insulating layer 34a is applied to the surface of the bottom surface side conductor layer 4a (the surface of the bottom surface side insulating layer 32 in a portion where the bottom surface side conductor layer 4a is not formed), and then exposed, developed, and hardened, thereby forming the intermediate insulating layer 34a. At this time, via holes are appropriately formed in the intermediate insulating layer 34a.

The intermediate insulating layer 34a may be formed by using a method other than the method described above. For example, a SiO₂ film or a ceramic film such as an alumina film that becomes the intermediate insulating layer 34a is formed on the surface of the bottom surface side conductor layer 4a (the surface of the bottom surface side insulating layer 32 in a portion where the bottom surface side conductor layer 4a is not formed). Thereafter, the SiO₂ film or the ceramic film is flattened by CMP or the like. Furthermore, via holes are appropriately formed by performing resist patterning based on photolithography, etching (RIE, wet etching, and the like), and resist peeling.

Then, a multilayer film that becomes the magnetic core portion 10a is formed on the surface of the intermediate insulating layer 34a. Hereinafter, a case of patterning a multilayer film by using a lift-off method will be described.

First, a resist is applied to the surface of the intermediate insulating layer 34a. The resist pattern is a pattern in which the resist is applied to a portion where the multilayer film is not formed finally. Then, the resist is exposed and developed so as to form an opening where a multilayer film that becomes the magnetic core portion 10a is to be formed.

The multilayer film can be formed by alternately forming the nanogranular magnetic film 12 and the soft magnetic alloy film 14.

There is no particular limitation on the method of forming the nanogranular magnetic film 12. For example, there is a method of forming the nanogranular magnetic film 12 by sputtering.

A sintered target obtained by sintering a mixture of a metal material and a ceramic material is prepared as a sputtering target. The metal material is mainly a metal contained in the first phase 12a. The ceramic material is mainly a compound contained in the second phase 12b.

Then, a nanogranular magnetic film is formed by sputtering using the above sintered target.

By changing the composition of the sintered target, the volume ratio of the first phase 12a to the total volume of the first phase 12a and the second phase 12b can be controlled. In addition, the film deposition speed can be controlled by controlling the voltage applied to the sintered target. In addition, the film deposition speed can be, for example, 1 Å/s or more and 200 Å/s or less.

By controlling the film deposition speed and the film deposition time, the thickness of the obtained nanogranular magnetic film 12 can be controlled.

By changing the distance between the sintered target and the intermediate insulating layer 34a, the film density of the obtained nanogranular magnetic film 12 can be changed. Specifically, the film density tends to increase as the distance between the sintered target and the intermediate insulating layer 34a decreases. Then, as the film density increases, the saturation magnetic flux density Bs tends to increase and the specific resistance ρ tends to decrease.

Instead of the sintered target described above, a sputtering target formed of a metal material and a sputtering target formed of a ceramic material may be separately prepared. In this case, the nanogranular magnetic film 12 is formed by multi-target simultaneous sputtering.

When the nanogranular magnetic film 12 is formed by multi-target simultaneous sputtering, the volume ratio of the first phase 12a to the total volume of the first phase 12a and the second phase 12b and the film deposition speed can be controlled by controlling the voltage applied to each sputtering target.

Furthermore, compositional separation between the first phase 12a and the second phase 12b can be promoted, in some cases, by subjecting the nanogranular magnetic film 12 to an annealing treatment. Then, the specific resistance ρ can be made even higher in some cases.

The temperature of the annealing treatment is not particularly limited, but may be about 200° C. to 300° C. The time of the annealing treatment is not particularly limited, but may be about 5 minutes to 240 minutes.

There is no particular limitation on the timing of the annealing treatment. For example, the annealing treatment may be performed after forming all the films included in the multilayer film.

There is no particular limitation on the method of forming the soft magnetic alloy film 14. A known method may be appropriately selected according to the desired composition and film thickness.

There is no particular limitation on the method of obtaining the multilayer film by alternately forming the nanogranular magnetic film 12 and the soft magnetic alloy film 14.

When forming both the nanogranular magnetic film 12 and the soft magnetic alloy film 14 by sputtering, if a film forming chamber for forming the nanogranular magnetic film 12 and a film forming chamber for forming the soft magnetic alloy film 14 are different, the support substrate 30 may be appropriately transported to each film forming chamber to form a film for each layer. When forming both the nanogranular magnetic film 12 and the soft magnetic alloy film 14 by sputtering, if a film forming chamber for forming the nanogranular magnetic film 12 and a film forming chamber for forming the soft magnetic alloy film 14 are the same, sputtering targets provided in the film forming chamber may be appropriately switched to form a film for each layer.

There is no particular limitation on the pressure of the rare gas and the film deposition time when forming the nanogranular magnetic film 12. There is no particular limitation on the pressure of the rare gas and the film deposition time when forming the soft magnetic alloy film 14. In addition, from the viewpoint of optimizing the tact time, the film deposition time when forming the nanogranular magnetic film 12 and the film deposition time when forming the soft magnetic alloy film 14 may be set to be the same. In order to do so, the pressure of the rare gas when forming the nanogranular magnetic film 12 and the pressure of the rare gas when forming the soft magnetic alloy film 14 may be appropriately adjusted.

At this point in time, SiO₂ or the like may be formed on the multilayer film as a protective film.

After forming the multilayer film, the resist and the multilayer film formed on the resist are removed. There is no particular limitation on the method of removing the resist and the multilayer film formed on the resist. For example, the multilayer film may be immersed in an organic solvent and subjected to ultrasonic waves.

Through the processes described above, the magnetic core portion 10a that is a multilayer film formed on the intermediate insulating layer 34a is obtained.

Then, the intermediate insulating layer 34b is formed on the surface of the magnetic core portion 10a (the surface of the intermediate insulating layer 34a in a portion where the magnetic core portion 10a is not formed), and the surface of the intermediate insulating layer 34b is smoothed. The method of forming the intermediate insulating layer 34b may be the same as the method of forming the intermediate insulating layer 34a.

When the intermediate insulating layer 34b is formed by using a photoresist that becomes the intermediate insulating layer 34b, via holes are formed at the same time. When forming a SiO₂ film or a ceramic film such as an alumina film that becomes the intermediate insulating layer 34b, via holes are formed by combining resist patterning based on photolithography and etching (RIE, ion milling, wet etching, and the like).

Then, the top surface side conductor layer 4b is formed. First, an electrode film is formed on the entire surface of the intermediate insulating layer 34b. There is no particular limitation on the method of forming the electrode film. For example, a sputtering method can be used. Then, a dry film resist is laminated on the surface of the electrode film. Then, the dry film resist is exposed and developed so as to form an opening where the top surface side conductor layer 4b is to be formed.

By plating, a plated film that becomes the top surface side conductor layer 4b is selectively deposited in the opening where the top surface side conductor layer 4b is to be formed. Thereafter, the dry film resist is removed by resist peeling. Furthermore, the electrode film in portions other than the bottom surface side conductor layer 4a is removed. There is no particular limitation on the method of removing the electrode film. For example, ion milling or dry etching can be used. By the processes described above, the patterned top surface side conductor layer 4b is formed.

In addition, by the plating described above, the via hole electrode for extraction 4c and the via hole electrode for connection 4d are formed inside the via hole. At the same time, the top surface side conductor layer 4b is formed so as to connect the via hole electrodes for connection 4d to each other. Thereafter, the dry film resist is removed by resist peeling as described above. By forming the top surface side conductor layer 4b in this manner, the bottom surface side conductor layer 4a and the top surface side conductor layer 4b are connected in series to each other through the via hole electrode for connection 4d, so that the solenoid type coil included in the coil portion 4 is formed.

When forming the top surface side insulating layer 36, the top surface side insulating layer 36 is formed on the entire surface of the top surface side conductor layer 4b (the surface of the intermediate insulating layer 34b in a portion where the top surface side conductor layer 4b is not formed). There is no particular limitation on the method of forming the top surface side insulating layer 36. The top surface side insulating layer 36 may be formed by using the same method as for the bottom surface side insulating layer 32 and the intermediate insulating layers 34a and 34b. Furthermore, a via hole penetrating the top surface side insulating layer 36 is formed.

Then, the extraction electrode 6 is formed in the via hole, and the extraction electrode 6 and the via hole electrode for extraction 4c are connected to each other. The extraction electrode 6 is exposed on the surface of the top surface side insulating layer 36 (the intermediate insulating layer 34b when the top surface side insulating layer 36 is not formed).

There is no particular limitation on the method of forming the extraction electrode 6. The extraction electrode 6 may be formed by using the same method as for the bottom surface side conductor layer 4a and the top surface side conductor layer 4b. Furthermore, a lead wire may be connected to the extraction electrode 6. Furthermore, an external electrode may be connected to the lead wire. There is no particular limitation on the method of forming the lead wire and the external electrode. The lead wire and the external electrode may be formed by using the same method as for the bottom surface side conductor layer 4a and the top surface side conductor layer 4b, or members obtained by connecting a member, such as a conducting wire, to the extraction electrode 6 may be used as the lead wire and the external electrode.

Furthermore, a pad may be formed on the external electrode as required. There is no particular limitation on the material of the pad. For example, the material of the pad may be Au.

There is no particular limitation on the method of forming the pad. For example, first, a resist is applied to the surface of the inductor 2. Then, the resist is exposed and developed so as to form an opening in which a pad is to be formed. Then, by gold deposition, Au is selectively deposited in the opening where a pad is to be formed. Thereafter, the resist is removed by resist peeling.

In the method of manufacturing the inductor 2 described above, the multilayer film is patterned by using the lift-off method, but the method of patterning the multilayer film is not particularly limited. For example, the multilayer film may be patterned by a method using ion milling.

When patterning the multilayer film by ion milling, the multilayer film is formed on the entire surface of the intermediate insulating layer 34a without applying a resist to the surface of the intermediate insulating layer 34a. Then, a dry film resist is laminated on the surface of the multilayer film. The resist pattern is a pattern in which the dry film resist is laminated in a portion where the multilayer film is finally formed. Then, the multilayer film in a portion where the dry film resist is not laminated is removed by ion milling. Thereafter, the dry film resist is removed to obtain the magnetic core portion 10a that is a multilayer film formed on the intermediate insulating layer 34a.

The inductor 2 according to the present embodiment manufactured in this manner may be embedded inside a circuit board, or may be mounted on a printed board and the like, or may be used in various electronic devices and the like. In addition, the inductor 2 may be formed in a CPU, a sensor, and the like.

The present invention is not limited to the embodiment described above, and various modifications can be made within the scope of the present invention. For example, an inductor in which a coil portion does not include a solenoid type coil may be used.

There is no particular limitation on the application of the inductor 2 according to the present invention. For example, there is an application that requires miniaturization and large current. Examples of the application include an AC/DC converter circuit, a DC/DC converter circuit, a transformer, a choke coil, and a filter.

### EXAMPLES

Hereinafter, the present invention will be described based on more detailed examples, but the present invention is not limited to these examples.

### Experimental Example 1

In Experimental Example 1, a single-layer film of a nanogranular magnetic film, a single-layer film of a soft magnetic alloy film, and a multilayer film in which a plurality of nanogranular magnetic films and a plurality of soft magnetic alloy films were alternately stacked, which are shown in Table 1, were formed, and the characteristics of each single-layer film and each multilayer film were measured. Hereinafter, a method of forming each single-layer film and each multilayer film and an evaluation method will be described.

(Method of Forming a Multilayer Film)

First, a sample substrate for forming a multilayer film was prepared. A Φ3″ silicon substrate with a thermal oxide film was prepared as a sample substrate. Then, a soft magnetic alloy film having the composition and film thickness shown in Table 1 was formed first on the sample substrate. Then, a nanogranular magnetic film having the composition of each phase shown in Table 1, the volume ratio of the first phase shown in Table 1, and the film thickness of the nanogranular magnetic film shown in Table 1 was formed on the soft magnetic alloy film. By alternately repeating the formation of the soft magnetic alloy film and the formation of the nanogranular magnetic film, a multilayer film having the number of stacked layers and the total film thickness shown in Table 1 was formed. A sputtering apparatus (SPF430H manufactured by CANON ANELVA CORPORATION) was used for film deposition. As the film forming conditions, the distance between the sputtering target and the sample substrate was set to 90 mm, and the sputtering power was set to 400 W. In addition, the gas pressure during film deposition was set to 0.3 Pa, and the atmosphere during film deposition was set to an Ar gas atmosphere. The film forming chamber for forming a nanogranular magnetic film and the film forming chamber for forming a soft magnetic alloy film were the same, and the sputtering targets provided in the film forming chamber were appropriately switched to form a film for each layer.

The number of stacked layers in this example is equal to the number of soft magnetic alloy films and equal to the number of nanogranular magnetic films. Therefore, in the multilayer film with the number of stacked layers of 2, the respective films are arranged in the order of the sample substrate, the soft magnetic alloy film, the nanogranular magnetic film, the soft magnetic alloy film, and the nanogranular magnetic film along the stacking direction.

Hereinafter, the method of forming each film will be described in more detail.

(Formation of a Soft Magnetic Alloy Film)

A sputtering target for a soft magnetic alloy film was prepared and attached to the gun. The composition of the sputtering target was appropriately selected so as to obtain a soft magnetic alloy film having a desired composition.

(Formation of a Nanogranular Magnetic Film)

A sintered target obtained by sintering a mixture of a metal material and a ceramic material was prepared as a sputtering target for a nanogranular magnetic film. The metal material was mainly a material that was a metal contained in the first phase 12a. The ceramic material was mainly a material that was a compound contained in the second phase 12b. The mixing ratio of the metal material and the ceramic material was appropriately controlled so that the volume ratio of the first phase shown in Table 1 was obtained.

In addition, the first phase may contain a small amount of impurities originating from the ceramic material. The second phase may contain a small amount of impurities originating from the metal material. However, such impurities are not considered in this example.

(Annealing Treatment)

Annealing treatment was performed after the multilayer film was formed. The annealing treatment conditions were 250° C. and 30 minutes in all examples and comparative examples.

(Method of Forming a Single-Layer Film)

A single-layer film of a nanogranular magnetic film was formed by using the same method as the method of forming a multilayer film except that a soft magnetic alloy film was not formed. In addition, a nanogranular magnetic film that is actually formed when there is no soft magnetic alloy film, the film thickness is 500 nm, and the number of stacked layers is 2 as in Sample 1 of Experimental Example 2 to be described later is a single-layer film of a nanogranular magnetic film having a film thickness of 1000 nm.

A single-layer film of a soft magnetic alloy film was formed by using the same method as the method of forming a multilayer film except that a nanogranular magnetic film was not formed.

(Characteristics of a Single-Layer Film and a Multilayer Film)

Whether or not the soft magnetic alloy film after the annealing treatment was an amorphous alloy was checked by using XRD (Empyrean manufactured by Panalytical). In Experimental Example 1 and Experimental Example 2 to be described later, all the soft magnetic alloy films were amorphous alloys except for Sample 25 in Table 5 to be described later. The soft magnetic alloy film of Sample 25 in Table 5 was formed of crystals.

It was confirmed by using XRF (Primus IV manufactured by Rigaku Corporation) that the volume ratio of the first phase to the total volume of the first phase and the second phase in the nanogranular magnetic film after the annealing treatment was the value shown in Table 1. Similar confirmation was also performed in Experimental Example 2 to be described later. The results are shown in Tables 2 to 9.

In Experimental Example 1 and Experimental Example 2 to be described later, in the nanogranular magnetic films after the annealing treatment of all examples, it was confirmed by using XRD (Empyrean manufactured by Panalytical) that the first phase had a crystal structure and the average crystal grain size of the crystals included in the crystal structure was 20 nm or less.

In Experimental Example 1 and Experimental Example 2 to be described later, it was confirmed by using a TEM (JEM-2100F manufactured by JEOL Ltd.) that the nanogranular magnetic film of each sample after the annealing treatment had a structure in which the nano-domains of the first phase were dispersed in the second phase. Furthermore, it was confirmed by using the TEM that the average size of the nano-domains of the first phase was 30 nm or less. Furthermore, the compositions of the first phase and the second phase were checked by using a TEM-EDS. The results of Experimental Example 1 are shown in Table 1, and the results of Experimental Example 2 are shown in Tables 2 to 9.

It was confirmed by using a stylus profilometer (KLA-Tencor P-16+) that the film thicknesses of the soft magnetic alloy film and the nanogranular magnetic film included in the multilayer film were the film thicknesses shown in Table 1. In addition, the total film thickness of the multilayer film was also checked by using the stylus profilometer. Furthermore, it was confirmed by using the stylus profilometer that the film thickness of the single-layer film in each comparative example was the film thickness shown in Table 1. Also in Experimental Example 2, which will be described later, the above film thicknesses were checked. The results are shown in Tables 2 to 9.

The saturation magnetic flux density Bs of each single-layer film and each multilayer film was measured by using VSM (TM-VSM331483-HGC) manufactured by TAMAKAWA CO., LTD. Specifically, for each single-layer film and each multilayer film obtained, the measurement was performed by using samples obtained by cutting a part of the substrate into a 6 mm square. The measured magnetic field was −10000 Oe to +10000 Oe. Furthermore, the Bs ratio of each single-layer film and each multilayer film to the saturation magnetic flux density Bs of a single-layer film A, which was a single-layer film of a nanogranular magnetic film, was calculated. The results of Experimental Example 1 are shown in Table 1, and the results of Experimental Example 2 are shown in Tables 2 to 9. When the Bs ratio was 1.03 or more, the saturation magnetic flux density Bs of the multilayer film was evaluated as good, and when the Bs ratio was 1.10 or more, the saturation magnetic flux density Bs of the multilayer film was evaluated as even better.

A method for measuring the specific resistance ρ in the direction perpendicular to plane of each single-layer film and each multilayer film will be described. First, a Φ3″ silicon substrate with a thermal oxide film was prepared. A Cu single-layer film 41 having a film thickness of 100 nm was formed by using the sputtering apparatus described above. The substrate after film deposition was cut into 10 mm×10 mm. The end surface of the obtained substrate was masked with a Kapton tape. Thereafter, each single-layer film or each multilayer film shown in Table 1 was formed as a measurement target film 43 on the Cu single-layer film 41 by using the method described above. The Kapton tape was removed after forming the measurement target film 43.

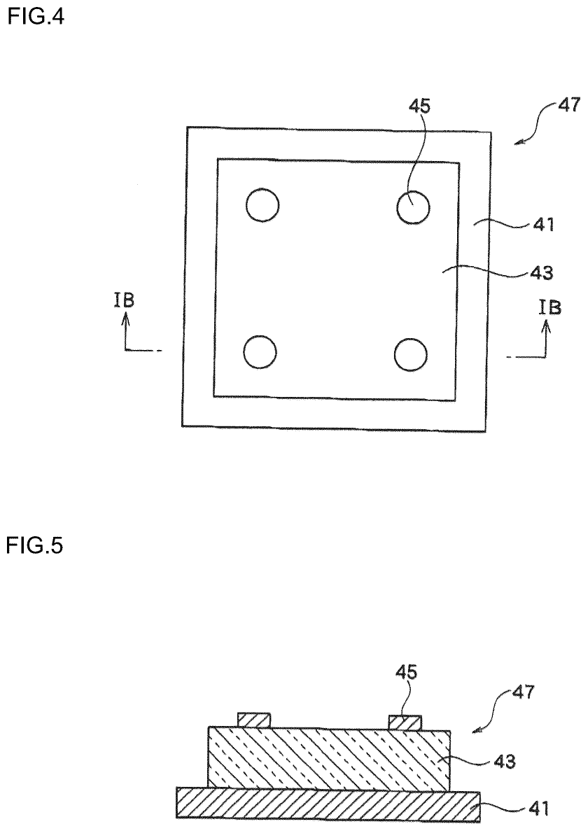

Then, the substrate was set on a metal mask having an opening of ϕ1 mm, and Cu was vapor-deposited by using a vapor deposition machine (ES650 manufactured by ULVAC, Inc.) to form a Cu terminal 45. As a result, a measurement sample 47 having a state shown in FIG. 4 when viewed from the side opposite to the substrate along the stacking direction of the measurement target film 43 and having a state shown in FIG. 5 as a cross-sectional view of the main part along the line IB-IB in FIG. 4 was obtained.

In FIG. 5, the substrate is omitted. There is no particular limitation on the position of the Cu terminal 45 and the number of Cu terminals 45 shown in FIGS. 4 and 5.

By using a probe capable of measuring electric resistance, the electric resistance of the measurement target film 43 between the Cu single-layer film 41 and the Cu terminal 45 was measured, and the specific resistance ρ was calculated. Furthermore, the ρ ratio of each single-layer film and each multilayer film to the specific resistance ρ of the single-layer film A, which was a single-layer film formed of a nanogranular magnetic film, was calculated. The results of Experimental Example 1 are shown in Table 1, and the results of Experimental Example 2 are shown in Tables 2 to 9.

A case where the specific resistance ρ was 2.0E-4 Ω·cm or more was evaluated as good. 2.0E-4 means 2.0×10⁻⁴. Furthermore, a case where the ρ ratio was 0.45 or more was evaluated as good, and a case where the ratio was 0.50 or more was evaluated as even better.

The magnetic loss tan δ of each single-layer film and each multilayer film in Experimental Example 1 was measured at a measurement frequency of 100 MHz by using a magnetic permeability measuring device (PMF-3000 manufactured by Ryowa Electronics Co., Ltd.). Specifically, for each single-layer film and each multilayer film obtained, the measurement was performed by using samples obtained by cutting a part of the substrate into a 6 mm square. Table 1 shows the results. In Experimental Example 1, a case where the magnetic loss tan δ was 0.1000 or less was evaluated as good.

TABLE 1

| | | | | Nanogranular magnetic film | | | |
|---|---|---|---|---|---|---|---|
| | | Soft magnetic alloy film | | First | Second | | |
| | | Composition | | phase | phase | | |
| | Example/ | Atomic | Film | Atomic | Atomic | V₁/ | Film |
| | Comparative | number | thickness | number | number | (V₁ + | thickness |
| | example | ratio | (nm) | ratio | ratio | V₂) | (nm) |
| Single-layer film A | Comparative | — | — | Co | SiO₂ | 0.50 | 5600 |
| | example | | | | | | |
| Single-layer film B | Comparative | Co_{93.5}Zr_{4.0}Ta_{2.5} | 5600 | — | — | — | — |
| | example | | | | | | |
| Multilayer film A | Example | Co_{93.5}Zr_{4.0}Ta_{2.5} | 100 | Co | SiO₂ | 0.50 | 600 |
| Multilayer film B | Example | Co_{93.5}Zr_{4.0}Ta_{2.5} | 200 | Co | SiO₂ | 0.50 | 500 |
| Multilayer film C | Example | Co_{93.5}Zr_{4.0}Ta_{2.5} | 300 | Co | SiO₂ | 0.50 | 400 |

| | Film structure | | | | | | |
|---|---|---|---|---|---|---|---|
| | The number | Total film | Film characteristics | | | | |
| | of stacked | thickness | Bs | Bs | ρ | ρ | tanδ |
| | layers | (nm) | (T) | ratio | (Ω cm) | ratio | (100 MHz) |
| Single-layer film A | — | 5600 | 0.76 | 1.00 | 1.1E−02 | 1.00 | 0.0024 |
| Single-layer film B | — | 5600 | 1.41 | 1.86 | 1.2E−04 | 0.01 | 0.8410 |
| Multilayer film A | 8 | 5600 | 0.82 | 1.08 | 9.4E−03 | 0.85 | 0.0027 |
| Multilayer film B | 8 | 5600 | 0.92 | 1.21 | 7.9E−03 | 0.72 | 0.0046 |
| Multilayer film C | 8 | 5600 | 1.01 | 1.33 | 6.3E−03 | 0.57 | 0.0063 |

From Table 1, when the total film thickness was 5600 nm, all of the multilayer films A to C having different film thickness ratios between the soft magnetic alloy film and the nanogranular magnetic film had a sufficiently high specific resistance p. Furthermore, the magnetic loss tan δ became sufficiently low as the specific resistance ρ became sufficiently high. In addition, there was a tendency that the higher the ratio of the nanogranular magnetic film, the lower the saturation magnetic flux density Bs and the higher the specific resistance p. Furthermore, the multilayer films A to C had an improved saturation magnetic flux density Bs compared with the single-layer film A formed of a nanogranular magnetic film.

The single-layer film B formed of a soft magnetic alloy film had a lower specific resistance ρ and a significantly higher magnetic loss tan δ than the multilayer films A to C.

In addition, the saturation magnetic flux density Bs and the specific resistance ρ hardly changed even if the film thickness of the single-layer film A was changed.

### Experimental Example 2

In Experimental Example 2, a single-layer film and a multilayer film having a smaller total film thickness than in Experimental Example 1 were mainly formed. In general, the smaller the film thickness, the smaller the magnetic loss tan δ However, when the total film thickness is small as in many single-layer films and multilayer films in Experimental Example 2, it is difficult to directly measure the magnetic loss tan δ as in Experimental Example 1.

Generally, if the film thickness is the same, the magnetic loss tan δ increases as the specific resistance ρ decreases. Therefore, even for a sample for which it is difficult to directly measure the magnetic loss tan δ because the total film thickness is small, the magnetic loss tan δ can be regarded as being sufficiently small if the specific resistance ρ is sufficiently large.

The method of forming each film in Experimental Example 2 is the same as in Experimental Example 1. In addition, in Experimental Example 2, the saturation magnetic flux density Bs of the soft magnetic alloy film included in each sample was measured. This shows the results of measuring the saturation magnetic flux density Bs in a case where the single-layer film of each soft magnetic alloy film included in each sample was formed by using the same method as in Experimental Example 1. For example, the saturation magnetic flux density Bs of the soft magnetic alloy film of Sample 6 in Table 2 is the saturation magnetic flux density Bs of a soft magnetic alloy film having a film thickness of 200 nm and a composition of Co_{93.5}Zr_{4.0}Ta_{2.5} in terms of atomic number ratio.

TABLE 2

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 1 | Comparative | None | — | 0 | Co | SiO₂ | 0.35 | 700 |
| | example | | | | | | | |
| Sample 2 | Example | Co_{93.5}Zr_{4.0}Ta_{2.5} | 1.41 | 200 | Co | SiO₂ | 0.35 | 500 |
| Sample 3 | Comparative | None | — | 0 | Co | SiO₂ | 0.40 | 700 |
| | example | | | | | | | |
| Sample 4 | Example | Co_{93.5}Zr_{4.0}Ta_{2.5} | 1.41 | 200 | Co | SiO₂ | 0.40 | 500 |
| Sample 5 | Comparative | None | — | 0 | Co | SiO₂ | 0.50 | 700 |
| | example | | | | | | | |
| Sample 6 | Example | Co_{93.5}Zr_{4.0}Ta_{2.5} | 1.41 | 200 | Co | SiO₂ | 0.50 | 500 |
| Sample 7 | Comparative | None | — | 0 | Co | SiO₂ | 0.60 | 700 |
| | example | | | | | | | |
| Sample 8 | Example | Co_{93.5}Zr_{4.0}Ta_{2.5} | 1.41 | 200 | Co | SiO2 | 0.60 | 500 |
| Sample 7a | Comparative | None | — | 0 | Co | SiO₂ | 0.65 | 700 |
| | example | | | | | | | |
| Sample 8a | Example | Co_{93.5}Zr_{4.0}Ta_{2.5} | 1.41 | 200 | Co | SiO2 | 0.65 | 500 |
| Sample 9 | Comparative | None | — | 0 | Co | SiO₂ | 0.70 | 700 |
| | example | | | | | | | |
| Sample 10 | Comparative | Co_{93.5}Zr_{4.0}Ta_{2.5} | 1.41 | 200 | Co | SiO₂ | 0.70 | 500 |
| | example | | | | | | | |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 1 | 0.00 | 2 | 1400 | 0.38 | 1.00 | 1.5E+00 | 1.00 |
| Sample 2 | 0.40 | 2 | 1400 | 0.62 | 1.45 | 1.0E+00 | 0.70 |
| Sample 3 | 0.00 | 2 | 1400 | 0.52 | 1.00 | 2.5E−01 | 1.00 |
| Sample 4 | 0.40 | 2 | 1400 | 0.75 | 1.45 | 1.8E−01 | 0.71 |
| Sample 5 | 0.00 | 2 | 1400 | 0.76 | 1.00 | 1.1E−02 | 1.00 |
| Sample 6 | 0.40 | 2 | 1400 | 0.92 | 1.21 | 7.9E−03 | 0.72 |
| Sample 7 | 0.00 | 2 | 1400 | 0.98 | 1.00 | 7.7E−04 | 1.00 |
| Sample 8 | 0.40 | 2 | 1400 | 1.08 | 1.10 | 5.8E−04 | 0.75 |
| Sample 7a | 0.00 | 2 | 1400 | 1.07 | 1.00 | 3.1E−04 | 1.00 |
| Sample 8a | 0.40 | 2 | 1400 | 1.15 | 1.07 | 2.4E−04 | 0.77 |
| Sample 9 | 0.00 | 2 | 1400 | 1.20 | 1.00 | 1.4E−04 | 1.00 |
| Sample 10 | 0.40 | 2 | 1400 | 1.23 | 1.02 | 1.3E−04 | 0.91 |

TABLE 3

| | | | | | | Nanogranular magnetic film | | |
|---|---|---|---|---|---|---|---|---|
| | | Soft magnetic alloy film | | | | First | Second | |
| | | Composition | | | | phase | phase | |
| | Example/ | Atomic | | | Film | Atomic | Atomic | V₁/ |
| Sample | Comparative | number | | Bs | thickness | number | number | (V₁ + |
| No. | example | ratio | cry/amo | (T) | (nm) | ratio | ratio | V₂) |
| Sample 5 | Comparative | None | — | — | 0 | Co | SiO₂ | 0.50 |
| | example | | | | | | | |
| Sample 6 | Example | Co_{93.5}Zr_{4.0}Ta_{2.5} | amorphous | 1.41 | 200 | Co | SiO₂ | 0.50 |
| Sample 11 | Example | Fe₇₇Si₁₁B₁₁Cr₁ | amorphous | 1.40 | 200 | Co | SiO₂ | 0.50 |
| Sample 12 | Example | Fe₇₄Si₁₁B₁₁Cr₄ | amorphous | 1.25 | 200 | Co | SiO₂ | 0.50 |
| Sample 13 | Example | Fe₇₀Si₁₁B₁₁Cr₈ | amorphous | 1.08 | 200 | Co | SiO₂ | 0.50 |
| Sample 14 | Example | (Fe_{0.8}Co_{0.2})₈₂Ta₈C₆B₄ | amorphous | 1.65 | 200 | Co | SiO₂ | 0.50 |
| Sample 15 | Example | (Fe_{0.2}Co_{0.8})₈₂Ta₈C₆B₄ | amorphous | 1.55 | 200 | Co | SiO₂ | 0.50 |
| Sample 16 | Example | (Fe_{0.6}Co_{0.4})₈₂Ta₈C₆B₄ | amorphous | 1.62 | 200 | Co | SiO₂ | 0.50 |
| Sample 17 | Example | (Fe_{0.6}Co_{0.3}Ni_{0.1})₈₂Ta₈C₆B₄ | amorphous | 1.62 | 200 | Co | SiO₂ | 0.50 |
| Sample 18 | Comparative | Fe₆₀Si₁₇B₁₅Cr₈ | amorphous | 0.76 | 200 | Co | SiO₂ | 0.50 |
| | example | | | | | | | |

| | | Multilayer film | | | | | | |
|---|---|---|---|---|---|---|---|---|
| | | | The | | | | | |
| | Nanogranular magnetic film | | number | | | | | |
| | Film | Film | of | Total film | | | | |
| Sample | thickness | thickness | stacked | thickness | Bs | Bs | ρ | ρ |
| No. | (nm) | ratio | layers | (nm) | (T) | ratio | (Ω cm) | ratio |
| Sample 5 | 700 | 0.00 | 2 | 1400 | 0.76 | 1.00 | 1.1E−02 | 1.00 |
| Sample 6 | 500 | 0.40 | 2 | 1400 | 0.92 | 1.21 | 7.9E−03 | 0.72 |
| Sample 11 | 500 | 0.40 | 2 | 1400 | 0.92 | 1.21 | 7.9E−03 | 0.72 |
| Sample 12 | 500 | 0.40 | 2 | 1400 | 0.87 | 1.15 | 7.9E−03 | 0.72 |
| Sample 13 | 500 | 0.40 | 2 | 1400 | 0.83 | 1.09 | 7.9E−03 | 0.72 |
| Sample 14 | 500 | 0.40 | 2 | 1400 | 0.99 | 1.30 | 7.9E−03 | 0.72 |
| Sample 15 | 500 | 0.40 | 2 | 1400 | 0.96 | 1.26 | 7.9E−03 | 0.72 |
| Sample 16 | 500 | 0.40 | 2 | 1400 | 0.98 | 1.29 | 7.9E−03 | 0.72 |
| Sample 17 | 500 | 0.40 | 2 | 1400 | 0.98 | 1.29 | 7.9E−03 | 0.72 |
| Sample 18 | 500 | 0.40 | 2 | 1400 | 0.74 | 0.97 | 7.9E−03 | 0.72 |

TABLE 4

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 19 | Comparative | None | — | 0 | Co | SiO₂ | 0.50 | 500 |
| | example | | | | | | | |
| Sample 20 | Example | Co_{93.5}Zr_{4.0}Ta_{2.5} | 1.39 | 50 | Co | SiO₂ | 0.50 | 500 |
| Sample 21 | Example | Co_{93.5}Zr_{4.0}Ta_{2.5} | 1.41 | 100 | Co | SiO₂ | 0.50 | 500 |
| Sample 6 | Example | Co_{93.5}Zr_{4.0}Ta_{2.5} | 1.41 | 200 | Co | SiO₂ | 0.50 | 500 |
| Sample 22 | Example | Co_{93.5}Zr_{4.0}Ta_{2.5} | 1.41 | 300 | Co | SiO₂ | 0.50 | 500 |
| Sample 23 | Example | Co_{93.5}Zr_{4.0}Ta_{2.5} | 1.41 | 500 | Co | SiO₂ | 0.50 | 500 |
| Sample 24 | Example | Co_{93.5}Zr_{4.0}Ta_{2.5} | 1.40 | 600 | Co | SiO₂ | 0.50 | 500 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 19 | 0.00 | 2 | 1000 | 0.76 | 1.00 | 1.1E−02 | 1.00 |
| Sample 20 | 0.10 | 2 | 1100 | 0.79 | 1.05 | 1.0E−02 | 0.91 |
| Sample 21 | 0.20 | 2 | 1200 | 0.84 | 1.11 | 9.2E−03 | 0.83 |
| Sample 6 | 0.40 | 2 | 1400 | 0.92 | 1.21 | 7.9E−03 | 0.72 |
| Sample 22 | 0.60 | 2 | 1600 | 0.98 | 1.28 | 6.9E−03 | 0.63 |
| Sample 23 | 1.00 | 2 | 2000 | 1.05 | 1.39 | 5.5E−03 | 0.50 |
| Sample 24 | 1.20 | 2 | 2200 | 1.08 | 1.42 | 5.1E−03 | 0.46 |

TABLE 5

| | | | | | | Nanogranular magnetic film | | | |
|---|---|---|---|---|---|---|---|---|---|
| | | Soft magnetic alloy film | | | | First | Second | | |
| | | Composition | | | | phase | phase | | |
| | Example/ | Atomic | | | Film | Atomic | Atomic | V₁/ | Film |
| Sample | Comparative | number | | Bs | thickness | number | number | (V₁ + | thickness |
| No. | example | ratio | cry/amo | (T) | (nm) | ratio | ratio | V₂) | (nm) |
| Sample 5 | Comparative | None | — | — | 0 | Co | SiO₂ | 0.50 | 700 |
| | example | | | | | | | | |
| Sample 6 | Example | Co_{93.5}Zr_{4.0}Ta_{2.5} | amorphous | 1.41 | 200 | Co | SiO₂ | 0.50 | 500 |
| Sample 11 | Example | Fe₇₇Si₁₁B₁₁Cr₁ | amorphous | 1.40 | 200 | Co | SiO₂ | 0.50 | 500 |
| Sample 25 | Example | Ni₈₁Fe₁₉ | crystal | 0.88 | 200 | Co | SiO₂ | 0.50 | 500 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 5 | 0.00 | 2 | 1400 | 0.76 | 1.00 | 1.1E−02 | 1.00 |
| Sample 6 | 0.40 | 2 | 1400 | 0.92 | 1.21 | 7.9E−03 | 0.72 |
| Sample 11 | 0.40 | 2 | 1400 | 0.92 | 1.21 | 7.9E−03 | 0.72 |
| Sample 25 | 0.40 | 2 | 1400 | 0.78 | 1.03 | 7.9E−03 | 0.72 |

TABLE 6

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 5 | Comparative | None | — | 0 | Co | SiO₂ | 0.50 | 700 |
| | example | | | | | | | |
| Sample 6 | Example | Co_{93.5}Zr_{4.0}Ta_{2.5} | 1.41 | 200 | Co | SiO₂ | 0.50 | 500 |
| Sample 26 | Comparative | None | — | 0 | Co | SiO₂ | 0.50 | 700 |
| | example | | | | | | | |
| Sample 27 | Example | Co_{93.5}Zr_{4.0}Ta_{2.5} | 1.41 | 200 | Co | SiO₂ | 0.50 | 500 |
| Sample 28 | Comparative | None | — | 0 | Co | SiO₂ | 0.50 | 700 |
| | example | | | | | | | |
| Sample 29 | Example | Co_{93.5}Zr_{4.0}Ta_{2.5} | 1.41 | 200 | Co | SiO₂ | 0.50 | 500 |
| Sample 30 | Comparative | None | — | 0 | Co | SiO₂ | 0.50 | 700 |
| | example | | | | | | | |
| Sample 31 | Example | Co_{93.5}Zr_{4.0}Ta_{2.5} | 1.41 | 200 | Co | SiO₂ | 0.50 | 500 |
| Sample 32 | Comparative | None | — | 0 | Co | SiO₂ | 0.50 | 700 |
| | example | | | | | | | |
| Sample 33 | Example | Co_{93.5}Zr_{4.0}Ta_{2.5} | 1.41 | 200 | Co | SiO₂ | 0.50 | 500 |
| Sample 34 | Comparative | None | — | 0 | Co | SiO₂ | 0.50 | 700 |
| | example | | | | | | | |
| Sample 35 | Example | Co_{93.5}Zr_{4.0}Ta_{2.5} | 1.41 | 200 | Co | SiO₂ | 0.50 | 500 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 5 | 0.00 | 2 | 1400 | 0.76 | 1.00 | 1.1E−02 | 1.00 |
| Sample 6 | 0.40 | 2 | 1400 | 0.92 | 1.21 | 7.9E−03 | 0.72 |
| Sample 26 | 0.00 | 4 | 2800 | 0.75 | 1.00 | 1.1E−02 | 1.00 |
| Sample 27 | 0.40 | 4 | 2800 | 0.91 | 1.21 | 7.8E−03 | 0.78 |
| Sample 28 | 0.00 | 6 | 4200 | 0.75 | 1.00 | 1.0E−02 | 1.00 |
| Sample 29 | 0.40 | 6 | 4200 | 0.90 | 1.20 | 7.8E−03 | 0.76 |
| Sample 30 | 0.00 | 15 | 10500 | 0.73 | 1.00 | 9.8E−03 | 1.00 |
| Sample 31 | 0.40 | 15 | 10500 | 0.87 | 1.19 | 7.3E−03 | 0.75 |
| Sample 32 | 0.00 | 30 | 21000 | 0.73 | 1.00 | 9.5E−03 | 1.00 |
| Sample 33 | 0.40 | 30 | 21000 | 0.87 | 1.19 | 7.0E−03 | 0.74 |
| Sample 34 | 0.00 | 72 | 50400 | 0.71 | 1.00 | 9.2E−03 | 1.00 |
| Sample 35 | 0.40 | 72 | 50400 | 0.84 | 1.18 | 6.7E−03 | 0.73 |

TABLE 7

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 36 | Comparative | None | — | 0 | Co | SiO₂ | 0.50 | 600 |
| | example | | | | | | | |
| Sample 37 | Example | Co_{93.5}Zr_{4.0}Ta_{2.5} | 1.41 | 200 | Co | SiO₂ | 0.50 | 400 |
| Sample 5 | Comparative | None | — | 0 | Co | SiO₂ | 0.50 | 700 |
| | example | | | | | | | |
| Sample 6 | Example | Co_{93.5}Zr_{4.0}Ta_{2.5} | 1.41 | 200 | Co | SiO₂ | 0.50 | 500 |
| Sample 38 | Comparative | None | — | 0 | Co | SiO₂ | 0.50 | 1200 |
| | example | | | | | | | |
| Sample 39 | Example | Co_{93.5}Zr_{4.0}Ta_{2.5} | 1.41 | 200 | Co | SiO₂ | 0.50 | 1000 |
| Sample 40 | Comparative | None | — | 0 | Co | SiO₂ | 0.50 | 2200 |
| | example | | | | | | | |
| Sample 41 | Example | Co_{93.5}Zr_{4.0}Ta_{2.5} | 1.41 | 200 | Co | SiO₂ | 0.50 | 2000 |
| Sample 42 | Example | Co_{93.5}Zr_{4.0}Ta_{2.5} | 1.41 | 300 | Co | SiO₂ | 0.50 | 2000 |
| Sample 43 | Example | Co_{93.5}Zr_{4.0}Ta_{2.5} | 1.41 | 500 | Co | SiO₂ | 0.50 | 2000 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 36 | 0.00 | 2 | 1200 | 0.76 | 1.00 | 1.1E−02 | 1.00 |
| Sample 37 | 0.50 | 2 | 1200 | 0.95 | 1.25 | 7.8E−03 | 0.67 |
| Sample 5 | 0.00 | 2 | 1400 | 0.76 | 1.00 | 1.1E−02 | 1.00 |
| Sample 6 | 0.40 | 2 | 1400 | 0.92 | 1.20 | 7.9E−03 | 0.72 |
| Sample 38 | 0.00 | 2 | 2400 | 0.75 | 1.00 | 1.1E−02 | 1.00 |
| Sample 39 | 0.20 | 2 | 2400 | 0.84 | 1.11 | 8.8E−03 | 0.83 |
| Sample 40 | 0.00 | 2 | 4400 | 0.75 | 1.00 | 1.0E−02 | 1.00 |
| Sample 41 | 0.10 | 2 | 4400 | 0.79 | 1.05 | 9.4E−03 | 0.91 |
| Sample 42 | 0.15 | 2 | 4600 | 0.82 | 1.08 | 9.0E−03 | 0.87 |
| Sample 43 | 0.25 | 2 | 5000 | 0.86 | 1.14 | 8.3E−03 | 0.80 |

TABLE 8

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 5 | Comparative | None | — | 0 | Co | SiO₂ | 0.50 | 700 |
| | example | | | | | | | |
| Sample 6 | Example | Co_{93.5}Zr_{4.0}Ta_{2.5} | 1.41 | 200 | Co | SiO₂ | 0.50 | 500 |
| Sample44 | Comparative | None | — | 0 | Co | ZnO | 0.50 | 700 |
| | example | | | | | | | |
| Sample45 | Example | Co_{93.5}Zr_{4.0}Ta_{2.5} | 1.41 | 200 | Co | ZnO | 0.50 | 500 |
| Sample46 | Comparative | None | — | 0 | Co | AlN | 0.50 | 700 |
| | example | | | | | | | |
| Sample47 | Example | Co_{93.5}Zr_{4.0}Ta_{2.5} | 1.41 | 200 | Co | AlN | 0.50 | 500 |
| Sample48 | Comparative | None | — | 0 | Co | MgF₂ | 0.50 | 700 |
| | example | | | | | | | |
| Sample49 | Example | Co_{93.5}Zr_{4.0}Ta_{2.5} | 1.41 | 200 | Co | MgF₂ | 0.50 | 500 |
| Sample50 | Comparative | None | — | 0 | Co | Al₂O₃ | 0.50 | 700 |
| | example | | | | | | | |
| Sample51 | Example | Co_{93.5}Zr_{4.0}Ta_{2.5} | 1.41 | 200 | Co | Al₂O₃ | 0.50 | 500 |
| Sample52 | Comparative | None | — | 0 | Co | GaO₂ | 0.50 | 700 |
| | example | | | | | | | |
| Sample53 | Example | Co_{93.5}Zr_{4.0}Ta_{2.5} | 1.41 | 200 | Co | GaO₂ | 0.50 | 500 |
| Sample54 | Comparative | None | — | 0 | Co | SiO₂ + Al₂O₃ | 0.50 | 700 |
| | example | | | | | | | |
| Sample55 | Example | Co_{93.5}Zr_{4.0}Ta_{2.5} | 1.41 | 200 | Co | SiO₂ + Al₂O₃ | 0.50 | 500 |
| Sample56 | Comparative | None | — | 0 | Co | Si₃N₄•Al₂O₃ | 0.50 | 700 |
| | example | | | | | | | |
| Sample57 | Example | Co_{93.5}Zr_{4.0}Ta_{2.5} | 1.41 | 200 | Co | Si₃N₄•Al₂O₃ | 0.50 | 500 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 5 | 0.00 | 2 | 1400 | 0.76 | 1.00 | 1.1E−02 | 1.00 |
| Sample 6 | 0.40 | 2 | 1400 | 0.92 | 1.21 | 7.9E−03 | 0.72 |
| Sample44 | 0.00 | 2 | 1400 | 0.74 | 1.00 | 7.8E−03 | 1.00 |
| Sample45 | 0.40 | 2 | 1400 | 0.90 | 1.23 | 5.6E−03 | 0.72 |
| Sample46 | 0.00 | 2 | 1400 | 0.70 | 1.00 | 7.1E−03 | 1.00 |
| Sample47 | 0.40 | 2 | 1400 | 0.88 | 1.25 | 5.1E−03 | 0.72 |
| Sample48 | 0.00 | 2 | 1400 | 0.68 | 1.00 | 6.9E−03 | 1.00 |
| Sample49 | 0.40 | 2 | 1400 | 0.86 | 1.27 | 5.0E−03 | 0.72 |
| Sample50 | 0.00 | 2 | 1400 | 0.75 | 1.00 | 1.1E−02 | 1.00 |
| Sample51 | 0.40 | 2 | 1400 | 0.91 | 1.21 | 8.0E−03 | 0.72 |
| Sample52 | 0.00 | 2 | 1400 | 0.75 | 1.00 | 9.7E−03 | 1.00 |
| Sample53 | 0.40 | 2 | 1400 | 0.91 | 1.22 | 7.0E−03 | 0.72 |
| Sample54 | 0.00 | 2 | 1400 | 0.76 | 1.00 | 1.1E−02 | 1.00 |
| Sample55 | 0.40 | 2 | 1400 | 0.91 | 1.21 | 7.9E−03 | 0.73 |
| Sample56 | 0.00 | 2 | 1400 | 0.74 | 1.00 | 1.0E−02 | 1.00 |
| Sample57 | 0.40 | 2 | 1400 | 0.90 | 1.22 | 7.4E−03 | 0.72 |

TABLE 9

| | | | | | Nanogranular magnetic film | | | |
|---|---|---|---|---|---|---|---|---|
| | | Soft magnetic alloy film | | | First | Second | | |
| | | Composition | | | phase | phase | | |
| | Example/ | Atomic | | Film | Atomic | Atomic | V₁/ | Film |
| Sample | Comparative | number | Bs | thickness | number | number | (V₁ + | thickness |
| No. | example | ratio | (T) | (nm) | ratio | ratio | V₂) | (nm) |
| Sample 5 | Comparative | None | — | 0 | Co | SiO₂ | 0.50 | 700 |
| | example | | | | | | | |
| Sample 6 | Example | Co_{93.5}Zr_{4.0}Ta_{2.5} | 1.41 | 200 | Co | SiO₂ | 0.50 | 500 |
| Sample 58 | Comparative | None | — | 0 | Fe_{0.2}Co_{0.8} | SiO₂ | 0.50 | 700 |
| | example | | | | | | | |
| Sample 59 | Example | Co_{93.5}Zr_{4.0}Ta_{2.5} | 1.41 | 200 | Fe_{0.2}Co_{0.8} | SiO₂ | 0.50 | 500 |
| Sample 60 | Comparative | None | — | 0 | Fe_{0.6}Co_{0.4} | SiO₂ | 0.50 | 700 |
| | example | | | | | | | |
| Sample 61 | Example | Co_{93.5}Zr_{4.0}Ta_{2.5} | 1.41 | 200 | Fe_{0.6}Co_{0.4} | SiO₂ | 0.50 | 500 |
| Sample 62 | Comparative | None | — | 0 | Fe_{0.8}Co_{0.2} | SiO₂ | 0.50 | 700 |
| | example | | | | | | | |
| Sample 63 | Example | Co_{93.5}Zr_{4.0}Ta_{2.5} | 1.41 | 200 | Fe_{0.8}Co_{0.2} | SiO₂ | 0.50 | 500 |
| Sample 64 | Comparative | None | — | 0 | Fe | SiO₂ | 0.50 | 700 |
| | example | | | | | | | |
| Sample 65 | Example | Co_{93.5}Zr_{4.0}Ta_{2.5} | 1.41 | 200 | Fe | SiO₂ | 0.50 | 500 |
| Sample 66 | Comparative | None | — | 0 | Fe_{0.8}B_{0.2} | SiO₂ | 0.50 | 700 |
| | example | | | | | | | |
| Sample 67 | Example | Co_{93.5}Zr_{4.0}Ta_{2.5} | 1.41 | 200 | Fe_{0.8}B_{0.2} | SiO₂ | 0.50 | 500 |
| Sample 68 | Comparative | None | — | 0 | Fe_{0.9}P_{0.1} | SiO₂ | 0.50 | 700 |
| | example | | | | | | | |
| Sample 69 | Example | Co_{93.5}Zr_{4.0}Ta_{2.5} | 1.41 | 200 | Fe_{0.9}P_{0.1} | SiO₂ | 0.50 | 500 |
| Sample 70 | Comparative | None | — | 0 | Fe_{0.9}C_{0.1} | SiO₂ | 0.50 | 700 |
| | example | | | | | | | |
| Sample 71 | Example | Co_{93.5}Zr_{4.0}Ta_{2.5} | 1.41 | 200 | Fe_{0.9}C_{0.1} | SiO₂ | 0.50 | 500 |
| Sample 72 | Comparative | None | — | 0 | Fe_{0.98}Cr_{0.02} | SiO₂ | 0.50 | 700 |
| | example | | | | | | | |
| Sample 73 | Example | Co_{93.5}Zr_{4.0}Ta_{2.5} | 1.41 | 200 | Fe_{0.98}Cr_{0.02} | SiO₂ | 0.50 | 500 |
| Sample 74 | Comparative | None | — | 0 | Fe_{0.98}Pt_{0.02} | SiO₂ | 0.50 | 700 |
| | example | | | | | | | |
| Sample 75 | Example | Co_{93.5}Zr_{4.0}Ta_{2.5} | 1.41 | 200 | Fe_{0.98}Pt_{0.02} | SiO₂ | 0.50 | 500 |

| | Multilayer film | | | | | | |
|---|---|---|---|---|---|---|---|
| | | The | | | | | |
| | | number | | | | | |
| | Film | of | Total film | | | | |
| Sample | thickness | stacked | thickness | Bs | Bs | ρ | ρ |
| No. | ratio | layers | (nm) | (T) | ratio | (Ω cm) | ratio |
| Sample 5 | 0.00 | 2 | 1400 | 0.76 | 1.00 | 1.1E−02 | 1.00 |
| Sample 6 | 0.40 | 2 | 1400 | 0.92 | 1.21 | 7.9E−03 | 0.72 |
| Sample 58 | 0.00 | 2 | 1400 | 0.77 | 1.00 | 1.0E−02 | 1.00 |
| Sample 59 | 0.40 | 2 | 1400 | 0.92 | 1.19 | 7.2E−03 | 0.71 |
| Sample 60 | 0.00 | 2 | 1400 | 0.81 | 1.00 | 9.5E−03 | 1.00 |
| Sample 61 | 0.40 | 2 | 1400 | 0.96 | 1.18 | 6.8E−03 | 0.72 |
| Sample 62 | 0.00 | 2 | 1400 | 0.83 | 1.00 | 9.1E−03 | 1.00 |
| Sample 63 | 0.40 | 2 | 1400 | 0.98 | 1.18 | 6.5E−03 | 0.71 |
| Sample 64 | 0.00 | 2 | 1400 | 0.80 | 1.00 | 8.4E−03 | 1.00 |
| Sample 65 | 0.40 | 2 | 1400 | 0.95 | 1.19 | 6.1E−03 | 0.73 |
| Sample 66 | 0.00 | 2 | 1400 | 0.69 | 1.00 | 1.3E−02 | 1.00 |
| Sample 67 | 0.40 | 2 | 1400 | 0.86 | 1.25 | 8.7E−03 | 0.70 |
| Sample 68 | 0.00 | 2 | 1400 | 0.72 | 1.00 | 1.0E−02 | 1.00 |
| Sample 69 | 0.40 | 2 | 1400 | 0.89 | 1.24 | 7.4E−03 | 0.73 |
| Sample 70 | 0.00 | 2 | 1400 | 0.72 | 1.00 | 1.1E−02 | 1.00 |
| Sample 71 | 0.40 | 2 | 1400 | 0.89 | 1.24 | 8.0E−03 | 0.72 |
| Sample 72 | 0.00 | 2 | 1400 | 0.78 | 1.00 | 8.7E−03 | 1.00 |
| Sample 73 | 0.40 | 2 | 1400 | 0.94 | 1.21 | 6.3E−03 | 0.73 |
| Sample 74 | 0.00 | 2 | 1400 | 0.80 | 1.00 | 8.9E−03 | 1.00 |
| Sample 75 | 0.40 | 2 | 1400 | 0.95 | 1.19 | 6.6E−03 | 0.74 |

Table 2 shows examples and comparative examples carried out under the same conditions except that the volume ratio of the first phase to the total volume of the first phase and the second phase was changed. As the volume ratio of the first phase decreased, the saturation magnetic flux density Bs decreased and the specific resistance ρ increased. Examples of multilayer films showed good Bs ratio, ρ, and ρ ratio. However, Sample 10, in which the volume ratio of the first phase to the total volume of the first phase and the second phase was too large, had too low a Bs ratio. That is, even the multilayer film of the soft magnetic alloy film and the nanogranular magnetic film did not have a sufficiently improved saturation magnetic flux density Bs compared with the single-layer film of the nanogranular magnetic film. Furthermore, Sample 10, in which the volume ratio of the first phase to the total volume of the first phase and the second phase was too large, had too small a specific resistance p. Therefore, Sample 10 can be regarded as a sample with too high a magnetic loss tan δ.

Table 3 shows examples and comparative examples in which the composition of the soft magnetic alloy film was changed from that of Sample 6. When the soft magnetic alloy film contains one or more selected from Fe and Co and the total amount of Fe, Co, and Ni is 70 at % or more, the saturation magnetic flux density Bs of the soft magnetic alloy film was high, and the multilayer films of all the examples showed good Bs ratio, ρ, and ρ ratio. However, when the total amount of Fe, Co, and Ni was less than 70 at %, the saturation magnetic flux density Bs of the soft magnetic alloy film was low. As a result, the saturation magnetic flux density Bs decreased as compared with a case where the soft magnetic alloy film was not included.

Table 4 shows examples and comparative examples carried out under the same conditions except that the film thickness of each soft magnetic alloy film was changed from that of Sample 6. The multilayer films of all examples showed good Bs ratio, ρ, and ρ ratio. In particular, Samples 6 and 21 to 23, in which the film thickness per soft magnetic alloy film was equal to or less than the film thickness per nanogranular magnetic film and the film thickness per soft magnetic alloy film was 100 nm or more and 500 nm or less, showed particularly good Bs ratio and ρ ratio.

Table 5 shows examples and comparative examples in which the composition and microstructure of the soft magnetic alloy film were changed from those of Samples 6 and 11. Samples 6 and 11, in which the soft magnetic alloy film contains an Fe-based amorphous alloy or a Co-based amorphous alloy, had a particularly good saturation magnetic flux density Bs compared with Sample 25 in which the soft magnetic alloy film contains crystals.

Table 6 shows examples and comparative examples carried out under the same conditions except that the number of stacked layers was changed from those of Samples 5 and 6. Even if the number of stacked layers was changed, the multilayer films of all examples showed good Bs ratio, ρ, and ρ ratio. In addition, the magnetic loss tan δ was measured for Samples 31, 33, and 35 by using the same method as in Experimental Example 1. Samples 31, 33, and 35 had a magnetic loss tan δ of 0.100 or less as in each example of Experimental Example 1.

Table 7 shows examples and comparative examples carried out under the same conditions except that the film thickness of each nanogranular magnetic film was changed from those of Samples 5 and 6. Even if the film thickness of each nanogranular magnetic film was changed, the multilayer films of all examples showed good Bs ratio, p, and ρ ratio.

Tables 8 and 9 show examples and comparative examples carried out under the same conditions except that the composition of the nanogranular magnetic film was changed from those of Samples 5 and 6. In Samples 54 and 55 in Table 8, the second phase contained SiO₂ and Al₂O₃ at a volume ratio of 1:1. Even if the composition of the nanogranular magnetic film was changed, the multilayer films of all examples showed good Bs ratio and ρ ratio.

### Experimental Example 3

The multilayer films of each example and the single-layer films of each comparative example in Experimental Example 2 were appropriately selected and used for a magnetic core portion to manufacture the inductor shown in FIGS. 1 and 2, that is, an inductor with a solenoid type coil. The method of manufacturing an inductor was the method shown in the embodiment of the present invention. Hereinafter, detailed conditions will be described. Patterning of the multilayer film was performed by using the lift-off method.

A silicon wafer with a thermal oxide film was used as the support substrate 30.

The bottom surface side insulating layer 32 was an insulating layer formed of silicon oxide. The insulating layer formed of silicon oxide was formed by CVD using tetraethoxysilane (TEOS) as a raw material. As a CVD apparatus, PD-270STN manufactured by Samco was used. The thickness of the bottom surface side insulating layer 32 was set to 100 nm.

An electrode film was formed by sputtering. The film forming apparatus and the film forming conditions were all the same as in the sputtering in Experimental Examples 1 and 2. The material of the electrode film was copper.

Plating for forming the bottom surface side conductor layer 4a and the top surface side conductor layer 4b was copper plating using a plating solution containing copper sulfate as a main component. In addition, the thickness of the bottom surface side conductor layer 4a and the thickness of the top surface side conductor layer 4b in the finally obtained inductor were set to 100 nm. After forming the electrode film, RY-5115 manufactured by Showa Denko Materials Co., Ltd. was used as a dry film resist formed before plating.

The thickness of the coil, that is, the distance between the bottom surface side conductor layer 4a and the top surface side conductor layer 4b in the Z-axis direction was set to 3 μm.

The intermediate insulating layers 34a and 34b were formed by applying a photoresist to appropriate portions and then performing exposure, development and hardening. SU-8 manufactured by Nippon Kayaku Co., Ltd. was used as a photoresist. The hardening treatment was performed by heat treatment at 200° C. for 1 hour. Exposure was performed by a soft contact method using an aligner.

AZ5214 manufactured by Merck was used as a resist applied to the surface of the intermediate insulating layer 34a. A multilayer film or a single-layer film to be the magnetic core portion 10a was deposited by sputtering. The film forming apparatus and the film forming conditions were all the same as in the sputtering in Experimental Examples 1 and 2.

The inductor shown in FIGS. 1 and 2 manufactured by using the multilayer film of each example for the magnetic core portion 10a had better characteristics than the inductor shown in FIGS. 1 and 2 manufactured by using the single-layer film or the multilayer film of each comparative example for the magnetic core portion 10a.

### REFERENCE SIGNS LIST

2 inductor
4 coil portion
4a bottom surface side conductor layer
4b top surface side conductor layer
4c via hole electrode for extraction
4d via hole electrode for connection
5d via hole
6 extraction electrode
10a magnetic core portion
11a magnetic core center portion
11b, 11c magnetic core side portion
11d magnetic core connecting portion
11e slit portion
12 nanogranular magnetic film
12a first phase
12b second phase
14 soft magnetic alloy film
30 support substrate
32 bottom surface side insulating layer
34a, 34b intermediate insulating layer
36 top surface side insulating layer
41 Cu single-layer film
43 measurement target film
45 Cu terminal
47 measurement sample

What is claimed is:

1. An inductor, comprising:
a magnetic core portion; and
a coil portion,
wherein the magnetic core portion is a multilayer film in which a nanogranular magnetic film and a soft magnetic alloy film are alternately stacked,
the nanogranular magnetic film has a structure in which nano-domains of a first phase are dispersed in a second phase,
the first phase contains one or more selected from Fe and Co, and the second phase contains one or more selected from O, N, and F,
a volume ratio of the first phase to a total volume of the first phase and the second phase is 65% or less,
the soft magnetic alloy film contains one or more selected from Fe and Co, and
a total amount of Fe, Co, and Ni in the soft magnetic alloy film is 70 at % or more.

2. The inductor according to claim 1,
wherein a film thickness of the soft magnetic alloy film is equal to or less than a film thickness of the nanogranular magnetic film, and
the film thickness of the soft magnetic alloy film is 100 nm or more and 500 nm or less.

3. The inductor according to claim 1,
wherein the first phase has a crystal structure, and
an average crystal grain size of crystals contained in the crystal structure is 20 nm or less.

4. The inductor according to claim 1,
wherein the soft magnetic alloy film contains an Fe-based amorphous alloy or a Co-based amorphous alloy.

5. The inductor according to claim 1,
wherein the coil portion comprises a solenoid type coil.
